(19) United States
(12) Patent Application Publication
(10) Pub. No.: US 2012/0219027 A1
(43) Pub. Date: Aug. 30, 2012

(54) UV Laser System

(75) Inventors: Syunji SEKINE, Kanagawa (JP); Takao Izawa, Kanagawa (JP)

(73) Assignee: SHOWA OPTRONICS CO., LTD., Tokyo (JP)

(21) Appl. No.: 13/349,300

(22) Filed: Jan. 12, 2012

(30) Foreign Application Priority Data
Feb. 25, 2011 (JP) 2011-040876

(51) Int. Cl. H01S 3/10

(52) U.S. Cl. 372/22

(57) ABSTRACT

In a UV laser system, the problem of deposition of residues of organic substances on the surfaces of optical components is avoided so that the reduction in the laser output can be avoided. A wavelength converting crystal (10) used for the generation of a UV laser light is provided with a reflective plane (14) that selectively reflects the UV laser light (23) to cause the UV laser light to emit from a part of the wavelength converting crystal different from an optical path of a basic wavelength laser light (21). The residues may be deposited on the part of the wavelength converting crystal from which the UV laser light is emitted, but not in the part of thereof through which the basic wavelength laser light passes so that the generation process for the UV laser light is not affected by the deposition of the residues.

### TECHNICAL FIELD

The present invention relates to a UV (ultraviolet) laser system that produces UV laser light by frequency converting a basic wavelength laser light by using a wavelength converting crystal.

### BACKGROUND OF THE INVENTION

As illustrated in FIG. 9, a UV laser light having a frequency of 355 nm can be produced by converting a basic wavelength laser light 21 produced by a solid state laser medium 8 and having a wavelength of 1,064 nm into a second harmonic laser light 22 having a wavelength of 532 nm by using a wavelength converting crystal 9 such as KTP (KTiOPO₄), and performing a sum frequency conversion on the basic wavelength laser light 21 and the second harmonic laser light 22 to obtain a sum frequency laser light 23 having a wavelength of the 355 nm by using a wavelength converting crystal 10 such as LBO (LiB₃O₅).

In the conventional UV laser system, the basic wavelength laser light 21 and the second harmonic laser light 22 are allowed to travel through the wavelength converting crystal 10 and a reflection mirror 4 along a same light path as the UV laser or the sum frequency laser light 23. Therefore, when organic substances are contained in the air inside the housing 3 of the UV laser system 1, the UV laser light may cause the decomposition of the organic substances, and the produced residue to be deposited on the parts (X) of the surfaces of the wavelength converting crystal 10 and a reflection mirror 4 through which the UV laser light passes through. Such a deposition reduces the transmission and reflection coefficients of the basic wavelength laser light 21 and the second harmonic laser light 22 and/or damages the spatial coherence of the laser light with the result that the laser output may be diminished

As highly small quantities of organic substances could create this problem, and small amounts of organic substances are inevitably released from component parts and circuits boards within the system, it is not easy to keep organic substances away from the optical components of the laser system. As a measure to eliminate such a problem, it was proposed to constantly feed clean gas into the housing (in particular to the resonator) and thereby purge the inorganic substances from the housing (JP 10-244392A), and avoid the use of bonding agents and other organic substances that could contaminate the air inside the housing with any organic substances in constructing the UV laser system (JP 10-153746A).

However, constantly feeding clean gas into the resonator as proposed in JP 10-244392A requires a dedicated gas supply unit that would increase the cost and size of the UV laser system. Avoiding the use of bonding agents and other organic substances in the UV laser system requires a special bonding arrangement such as those involving the metallization of the surfaces of optical devices with low-melting point metals, and this not only increases the cost of the UV laser system but also complicates the manufacturing steps.

### BRIEF SUMMARY OF THE INVENTION

In view of such problems of the prior art, a primary object of the present invention is to provide a UV laser system that is free from the problem of deposition of residues of organic substances on the surfaces of optical components, and can thereby prevent the reduction in the laser output for an extended period of time.

A second object of the present invention is to provide a UV laser system that can prevent the deposition of residues of organic substances on the surfaces of optical components at low cost and without requiring any complications in the manufacturing steps.

According to a broad concept of the present invention, such objects can be accomplished by emitting the UV laser light (355 nm) from a different part of the surface of the wavelength converting crystal from the part of the surface of the wavelength converting crystal through which the basic wavelength laser light (1,064 nm) passes through. It is based on the recognition by the inventors that the deposition of the residues of organic substances adversely affects the transmission and reflection coefficients of the basic wavelength laser light, and thereby damages the spatial coherence of the laser light whereas the transmission of the UV laser light is little affected by the deposition of the residues of organic substances.

More specifically, the present invention accomplishes such objects by providing a UV laser system, comprising: a laser light source for producing a basic wavelength laser light; and a wavelength converting crystal for converting the basic wavelength laser into a UV laser light; wherein the wavelength converting crystal is provided with a reflective plane that selectively reflects one of the basic wavelength laser light and the UV laser light to cause the UV laser light to emit from a part of the wavelength converting crystal different from an optical path of the basic wavelength laser light in the wavelength converting crystal.

The residues of organic substances may be deposited on the part of the wavelength converting crystal from which the UV laser light is emitted, but not in the parts of the wavelength converting crystal through which the basic wavelength laser light passes. Therefore, the efficiency of generating the UV laser light can be avoided. The residues of organic substances may be deposited on the part of the wavelength converting crystal from which the UV laser light is emitted, but this does not affect the generation process of the UV laser light, and could cause only a slight decrease in the transmission of the UV laser light. This reduction is no more than 1% in most cases, and can be disregarded for practical purposes.

According to a preferred embodiment of the present invention, the UV laser system further comprises a device for converting a part of the basic wavelength laser light into a harmonic laser light, wherein the wavelength converting crystal is configured to sum frequency convert the basic wavelength laser and the harmonic laser light into the UV laser light.

According to a certain aspect of the present invention, the reflective plane is configured to reflect the UV laser light and transmit the basic wavelength laser light and the harmonic laser light. In this case, the reflective plane may be configured to reflect the UV laser light in a perpendicular direction or at an oblique angle less than 90 degrees.

Alternatively, the reflective plane may be configured to reflect the basic wavelength laser light and the second harmonic laser light and transmit the UV laser light. In this case also, the reflective plane may be configured to reflect the basic wavelength laser light and the second harmonic laser light in a perpendicular direction or at an oblique angle less than 90 degrees.

The reflective plane can be formed by joining a first crystal having a first optical surface coated with a reflective coating and a second crystal having a second optical surface overlaid on the first optical surface at the first and second optical surfaces. The first crystal and the second crystal may be joined to each other by optical contact at the first and second optical surfaces without using a bonding agent so that the problems associated with the release of organic substances from the bonding agent can be avoided and the two crystals can be joined at a high precision.

Preferably, the first crystal is cut at a crystal cut angle meeting a phase matching condition, and the second crystal is cut at a crystal cut angle deviating from the phase matching condition. Thereby, the basic wavelength laser light and/or the harmonic wavelength laser light that have passed through the reflective plane are prevented from being converted into a UV laser light as they travel through the second crystal so that the deposition of the residues of organic substances can be avoided at the surface from which the basic wavelength laser light and/or the harmonic wavelength laser light exit.

Preferably, the crystal cut angle of the second crystal deviates from that of the first crystal by a small angle such as 1 to 5 degrees. Thereby, the detachment of the two crystals at the optical surfaces due to uneven thermal expansion can be avoided even when the thermal expansion coefficient of the crystals may vary depending on the crystal direction.

### BRIEF DESCRIPTION OF THE DRAWINGS

Now the present invention is described in the following with reference to the appended drawings, in which:

FIG. 1 is a diagram showing a first embodiment of the UV laser system according to the present invention;

FIG. 2 is an enlarged view of the LBO crystal shown in FIG. 1;

FIG. 3 is a diagram showing the process of fabricating the LBO crystal shown in FIG. 1;

FIG. 4 is a view similar to FIG. 2 showing a second embodiment of the present invention;

FIG. 5 is a view similar to FIG. 2 showing a third embodiment of the present invention;

FIG. 6 is a view similar to FIG. 1 showing a fourth embodiment of the present invention;

FIG. 7 is an enlarged view of the LBO crystal shown in FIG. 6;

FIG. 8 is a view similar to FIG. 2 showing a fifth embodiment of the present invention; and

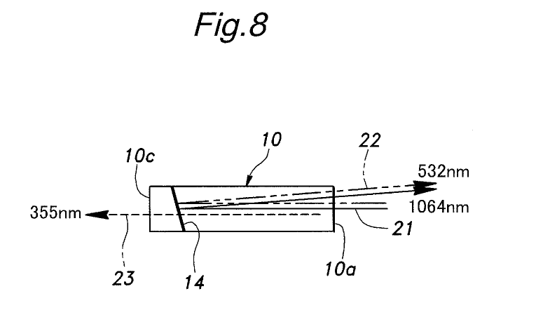

FIG. 9 is a view similar to FIG. 1 showing a UV laser system.

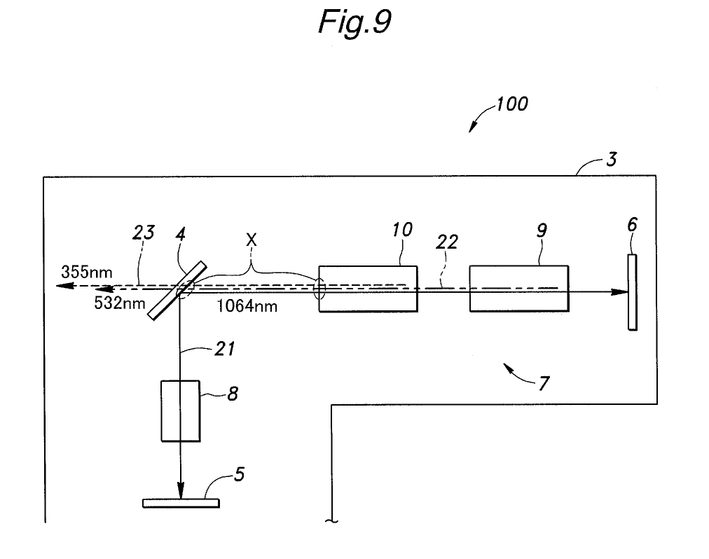

### DETAILED DESCRIPTION OF THE PREFERRED EMBODIMENT(S)

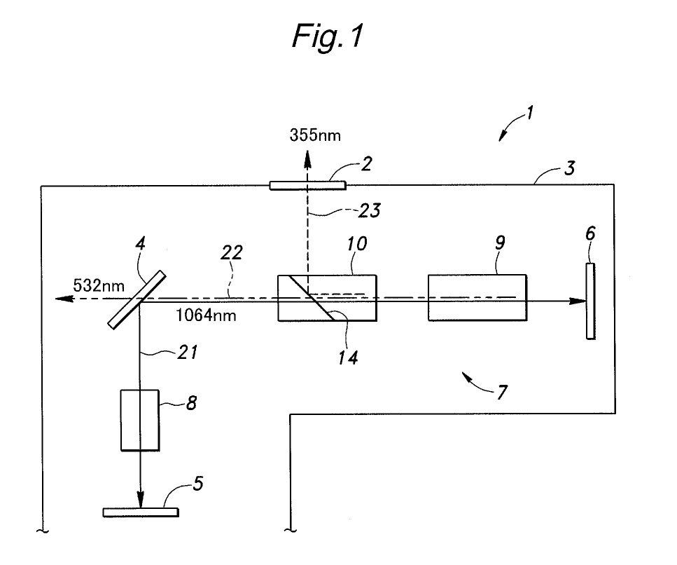

A UV laser system 1 embodying the present invention is described in the following with reference to FIGS. 1 to 3.

This UV laser system 1 is placed in a housing 3 provided with an output windows 2, and comprises a resonator 7 formed by a pair of resonator mirrors 5 and 6 opposing each other via a reflection mirror 4 such that the optical axial lines of the resonator mirrors 5 and 6 are perpendicular to each other. A solid state laser medium (ND: YVO₄) 8 is placed between the resonator mirror 5 and the reflection mirror 4. This solid state laser medium 8 is excited by a pumping diode laser (not shown in the drawings), and produces a basic wavelength laser light 21 having a wavelength of 1,064 nm by stimulated emission.

The resonator mirror 5 is configured to transmit the pumping laser light, and reflect the basic wavelength laser light 21 having the wavelength of 1,064 nm. The resonator minor 6 also reflects the basic wavelength laser light 21 having the wavelength of 1,064 nm. The terms “transmit” and “reflect” as used herein means that a large part of the light is transmitted or reflected, and do not necessarily means that the total transmission or total reflection occurs.

A KTP wavelength conversion crystal 9 and a LBO wavelength conversion crystal 10 are placed in that order in the light path from the resonator mirror 6 to the reflection mirror 4, Thus, the basic wavelength laser light 21 having the wavelength of 1,064 nm laser light emitted from the solid state laser medium 8 is amplified in the resonator 7 by resonance, and a part of the amplified laser light is converted into a second harmonic laser light 22 having a wavelength of 532 nm by the KTP wavelength conversion crystal 9. The reflection mirror 4 is configured to reflect the basic wavelength laser light 21 having the wavelength of 1,064 nm, and transmit the second harmonic light having a wavelength of 532 nm.

The basic wavelength laser light 21 having the wavelength of 1,064 nm laser light and the second harmonic laser light 22 having the wavelength of 532 nm are conducted along the optical axial line A between the reflection mirror 4 and the resonator mirror 6, and a part of these lights are frequency mixed (sum frequency generation) as they pass through the LBO wavelength conversion crystal 10 so that a sum frequency laser light 23 having a wavelength of 355 nm is produced. The sum frequency laser light 23 consists of a UV laser light. These lights 21, 22 and 23 pass coaxially along the light axis, but are shown laterally offset to each other in the drawings for the convenience of illustration.

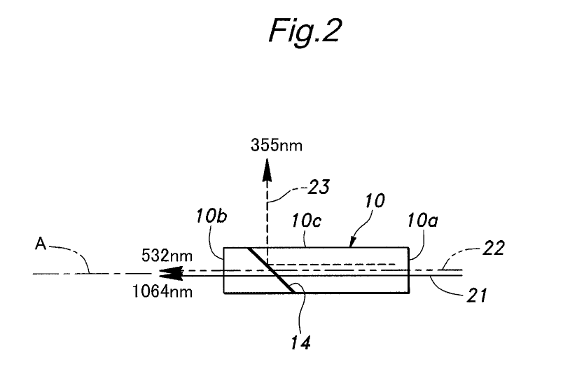

As shown in FIG. 2, the LBO wavelength conversion crystal 10 is provided with a rectangular cuboid shape, and internally defines a reflective plane 14 which is tilted with respect to the optical axial line A of the basic wavelength laser light 21 and the second harmonic laser light 22 by 45 degrees. The reflective plane 14 is configured to transmit the basic wavelength laser light 21 having the wavelength of 1,064 nm and the second harmonic laser light 22 having the wavelength of 532 nm, and reflect the sum frequency laser light 23 having the wavelength of 355 nm. The reflective plane 14 preferably constitutes a sole reflective plane within the LBO wavelength conversion crystal 10, but there may be two or more reflective planes in the LBO wavelength conversion crystal 10 to conduct the laser lights in desired directions.

The LBO wavelength conversion crystal 10 may be formed by a single optical member or a plurality of optical members that are brought in close contact with each other. More specifically, the LBO wavelength conversion crystal 10 may be formed by a pair of optical members which are in close contact with each other with a gap in the direction of the optical axial line being smaller than the wavelength of the laser light having the shortest wavelength or the second harmonic laser light 22 having the wavelength of the 532 nm.

The basic wavelength laser light 21 and the second harmonic laser light 22 that have entered the LBO wavelength conversion crystal 10 from a first surface 10a thereof travel straight through the reflective plane 14, and exit from a second surface 10b located on the opposite side along the optical axial line A and extends in parallel to the first surface 10a. The sum frequency laser light 23 having the wavelength of the 355 nm that is generated in the LBO wavelength conversion crystal 10 is reflected by the reflective plane 14, and thereby changes direction by 90 degrees with respect to the optical axial line to exit the LBO wavelength conversion crystal 10 from a third surface 10c in a direction perpendicular thereto (from a side surface of the LBO wavelength conversion crystal 10 which is perpendicular to the first surface 10a). The sum frequency laser light 23 then leaves the housing 3 via the output window 2 (FIG. 1).

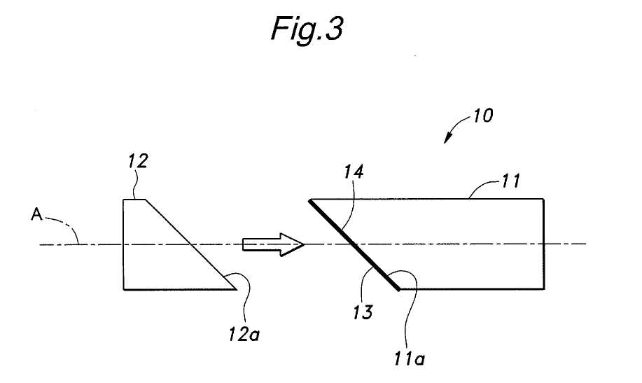

As shown in FIG. 3, the LBO wavelength conversion crystal 10 consists of a first LBO crystal 11 and a second LBO crystal 12 each having a slanting surface (optical surface) 11a, 11b. The two crystals 11 and 12 are shaped such that a rectangular cuboid is jointly formed by the two crystals 11 and 12 by abutting the slanting surfaces 11a and 11b to each other. The slanting surface 11a of the first LBO crystal 11 is coated with dielectric multi-layer film 13 so that the reflective plane 14 is defined at the interface between the two slanting surfaces 11a and 12a when the two slanting surfaces are brought into optical contact with each other.

The first LBO crystal 11 is cut such that the phase of the incident light consisting of the base wavelength laser light 21 and the second harmonic laser light 22 and the phase of the generated sum frequency laser light 23 match with each other along the entire length of the light path while the second LBO crystal 12 is cut at a crystal angle different from that of the first LBO crystal 11 so that such a phase matching does not occur. Therefore, the basic wavelength laser light 21 and the second harmonic laser light 22 that have passed through the reflective plane 14 are not substantially converted into a sum frequency laser light 23 as they travel through the second LBO crystal 12 so that the deposition of the residues of organic substances on the surface from which these laser lights exit the second LBO crystal 12 or the second surface 10b thereof can be avoided.

The LBO crystal is known to have a relatively large thermal expansion coefficient, and demonstrate different thermal expansion coefficients depending on the crystal direction. Therefore, if the first and second LBO crystals 11 and 12 are cut at substantially different crystal angles, there is a risk that the two crystals may be detached from each other owing to the different thermal coefficients thereof. Based on this consideration, it is preferred that the crystal cut angle of the second LBO crystal 12 is as close to that of the first LBO crystal 11 as possible without involving the phase matching. For this reason, the crystal cut angle of the second LBO crystal 12 is selected to differ from that of the first LBO crystal 11 by a small angle such as one to five degrees.

Owing to the reflective plane 14 that reflects the sum frequency laser light 23, the sum frequency laser light 23 or the UV laser light output is emitted from the third surface 10c, and not from the first and second surfaces 10a and 10b so that the deposition of the residues of organic substances on the first and second surfaces 10a and 10b that are on the light path of the basic wavelength laser light 21 emitted from the solid state laser medium 8 or the second harmonic laser light 22 emitted from the KTP wavelength conversion crystal 9 can be avoided.

The deposition of the residues of organic substances may occur on the third surface 10c, but this does not affect the transmission efficiency for the basic wavelength laser light 21 or the second harmonic laser light 22 so that the output efficiency of the UV laser system 1 can be maintained over an extended period of time. The drop in the transmission of the UV laser light through the third surface 10c of the LBO wavelength conversion crystal 10 due to the deposition of the residues of organic substances thereon may occur, but is no more than 1%, and is therefore insignificant from the practical view point.

As the UV laser light 23 can be separated from the basic wavelength laser light 21 and the second harmonic laser light 22 by forming the reflective plane 14 in the LBO wavelength conversion crystal 10 as discussed above, the service life of the UV laser system 1 can be maximized with a minimum cost.

According to the illustrated embodiment, the LBO wavelength conversion crystal 10 can be prepared by joining the first and second LBO crystals 11 and 12 by the complementary slanting surfaces 11a and 12a thereof and forming the reflective plane 14 in the LBO wavelength conversion crystal 10 by depositing a dielectric multi-film 13 or other reflective layer on the slanting surface 11a of the first LBO crystal 11. The first and second LBO crystals 11 and 12 may be joined by an optical contact without using a bonding agent so that the adverse effects (such as release of organic substances) of such a bonding agent can be avoided, and the first and second LBO crystals 11 and 12 can be joined at a high precision.

As the reflective plane 14 transmits the basic wavelength laser light 21 and the second harmonic laser light 22 while reflecting the sum frequency laser light 23, the light path for the basic wavelength laser light 21 and the second harmonic laser light 22 can be kept straight so that the resonator 7 can be formed in a conventional arrangement where the LBO wavelength conversion crystal 10 is placed in a straight optical path. Therefore, the complication of the optical arrangement for the UV laser system can be avoided, and a highly compact design is enabled.

As the reflective plane 14 is tilted with respect to the optical axis A of the basic wavelength laser light 21, and the sum frequency laser light 23 is allowed to exit the third surface 10c in a perpendicular direction thereto, the deposition of the residues of organic substances on the third surface 10c can be minimized, and this contributes to the increase in the service life of the UV laser system.

### Second Embodiment

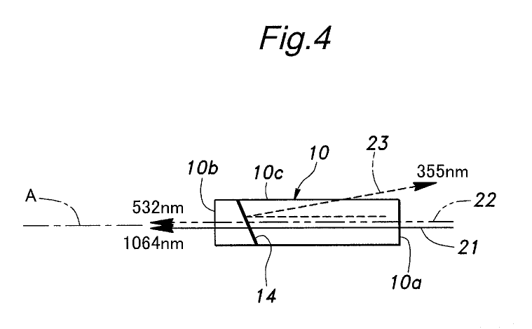

A second embodiment of the UV laser system of the present invention is described in the following with reference to FIG. 4. In FIG. 4 and other drawings illustrating different embodiments of the present invention, the parts corresponding to the previous embodiment are denoted with like numerals without repeating the description of such parts.

This embodiment differs from the first embodiment in that the reflective plane 14 is tilted with respect to the optical axial line A of the basic wavelength laser light 21 and the second harmonic laser light 22 by more than 45 degrees (but less than 90 degrees). The sum frequency laser light 22 generated in the LBO wavelength conversion crystal 10 is reflected by the reflective plane 14 to change direction by more than 90 degrees, and exits the LBO wavelength conversion crystal 10 from the third surface 10c thereof at an oblique angle. This sum frequency laser light 22 may be allowed to leave the UV laser system 1 from a windows 2 provided in the housing 3. This embodiment provides advantages similar to those of the first embodiment.

As a modification of the second embodiment, the reflective plane 14 may be tilted with respect to the optical axial line A of the basic wavelength laser light 21 and the second harmonic laser light 22 by less than 45 degrees so that the sum frequency laser light 22 generated in the LBO wavelength conversion crystal 10 is reflected by the reflective plane 14 to change direction by less than 90 degrees.

### Third Embodiment

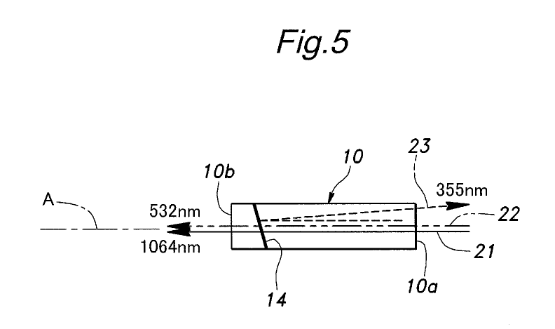

In the third embodiment shown in FIG. 5, the reflective plane 14 is tilted with respect to the optical axial line A of the basic wavelength laser light 21 and the second harmonic laser light 22 by significantly more than 45 degrees (but less than 90 degrees) such that the sum frequency laser light 22 generated in the LBO wavelength conversion crystal 10 is reflected by the reflective plane 14 and exits the LBO wavelength conversion crystal 10 from the first surface 10a thereof at an oblique angle at a part thereof offset from the optical axis A.

### Fourth Embodiment

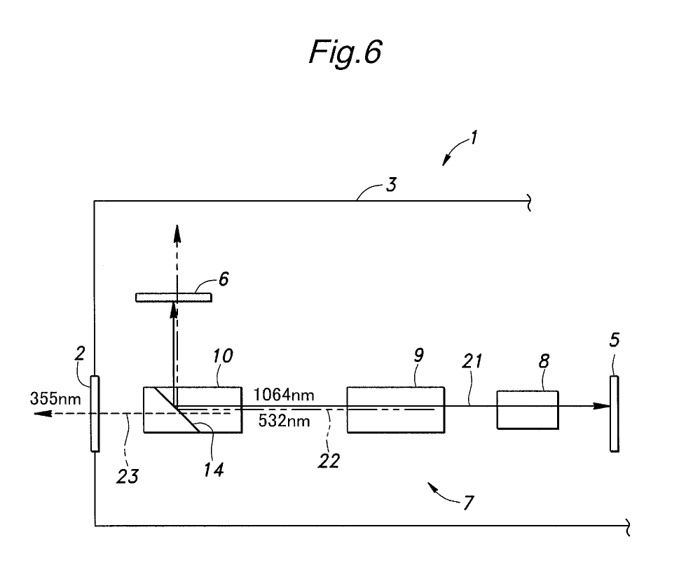

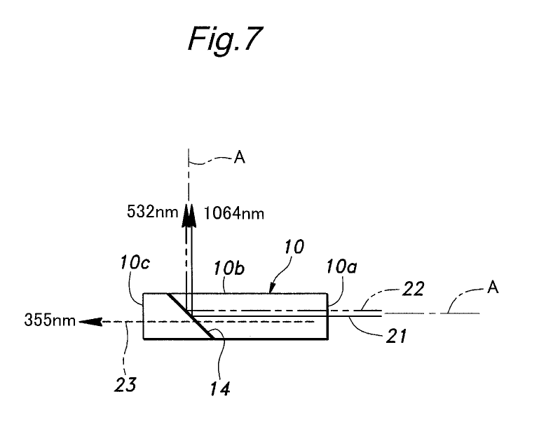

The fourth embodiment is described in the following with reference to FIGS. 6 and 7. In this case also, a resonator 7 is formed by a pair of resonator minors 5 and 6 interposing a reflective plane 14 of a LBO wavelength conversion crystal 10 therebetween that bends the light path by 90 degrees. A solid state laser medium 8, a KTP wavelength conversion crystal 9 and a LBO wavelength conversion crystal 10 are placed in that order in the straight light path from the resonator mirror 5. The resonator minor 5 transmits the pumping laser light, and reflects the basic wavelength laser light 21 generated in the solid state laser medium 8 and having a wavelength of 1,064 nm The resonator minor 6 reflects the basic wavelength laser light 21 having the wavelength of 1,064 nm, and transmits the second harmonic laser light 22 having a wavelength of 532 nm.

As shown in FIG. 7 also, the reflective plane 14 is tilted with respect to the optical axial line of the basic wavelength laser light 21 and the second harmonic laser light 22 by 45 degrees. The reflective plane 14 is configured to reflect the basic wavelength laser light 21 having the wavelength of 1,064 nm and the second harmonic laser light 22 having the wavelength of 532 nm, and transmit the sum frequency laser light 23 having the wavelength of 355 nm. Therefore, the basic wavelength laser light 21 and the second harmonic laser light 22 that have entered the LBO wavelength conversion crystal 10 from the first surface 10a are reflected by the reflective plane 14 to change direction by 90 degrees within the LBO wavelength conversion crystal 10, and exit the LBO wavelength conversion crystal 10 from the second surface 10b (which is perpendicular to the first surface 10a) in a perpendicular direction. On the other hand, the sum frequency laser light 23 having the wavelength of 355 nm generated in the LBO wavelength conversion crystal 10 is allowed to travel straight through the reflective plane 14 in the LBO wavelength conversion crystal 10, and exits the LBO wavelength conversion crystal 10 from the third surface 10c which is opposite to and in parallel to the first surface 10a. Thereafter, the sum frequency laser light 23 leaves the UV laser system 1 from the window 2.

In this embodiment, the reflective plane 14 reflects the basic wavelength laser light 21 having the wavelength of 1,064 nm and the second harmonic laser light 22 having the wavelength of 532 nm, and transmits the sum frequency laser light 23 having the wavelength of 355 nm. In the arrangement also, the sum frequency laser light 23 is allowed to exit the LBO wavelength conversion crystal 10 from a different surface (the third surface 10c) from the first and second surfaces 10a and 10b through which the optical path of the basic wavelength laser light 21 and the second harmonic laser light 22, and the reduction in the output of the UV laser device 1 can be avoided.

In this case, the crystal cut angle of the two parts of the LBO wavelength conversion crystal 10 separated by the reflective plane 14 may not have to be different from each other (or may be the same) as the generation in the entire part of the LBO wavelength conversion crystal 10 creates no problem, and the anisotropic property of the coefficient does not cause the detachment of the two parts of the LBO wavelength conversion crystal 10 from each other.

### Fifth Embodiment

The fifth embodiment differs from the fourth embodiment in that the reflective plane 14 is tilted with respect to the optical axial line A of the basic wavelength laser light 21 and the second harmonic laser light 22 by more than 45 degrees (but less than 90 degrees). The basic wavelength laser light 21 and the second harmonic laser light 22 are reflected by the reflective plane 14 to change direction by more than 90 degrees, and exit the LBO wavelength conversion crystal 10 from the first surface 10a from which the basic wavelength laser light 21 and the second harmonic laser light 22 are admitted into the LBO wavelength conversion crystal 10. The sum frequency laser light 22 generated in the LBO wavelength conversion crystal 10 is transmitted through the reflective plane 14, and exits the LBO wavelength conversion crystal 10 from the third surface 10c is opposite to and parallel to the first surface 10a.

Although not shown in the drawings, the reflective plane 14 may also be tilted with respect to the optical axial line A of the basic wavelength laser light 21 and the second harmonic laser light 22 to a slightly less extent such that the basic wavelength laser light 21 and the second ha tonic laser light 22 exit the LBO wavelength conversion crystal 10 from the second surface 10b which is perpendicular to the first surface 10a, at an oblique angle, similarly as in the third embodiment.

Although the present invention has been described in terms of preferred embodiments thereof, it is obvious to a person skilled in the art that various alterations and modifications are possible without departing from the scope of the present invention which is set forth in the appended claims. For instance, the wavelengths of the various laser lights in the given embodiments are purely exemplary, and may be different from those of the embodiments without departing from the spirit of the present invention. Also, the modes of frequency converting the basic wavelength laser light into a UV laser light given in the various embodiments are also purely exemplary, and may be modified without departing from the spirit of the present invention.

The contents of the original Japanese patent application on which the Paris Convention priority claim is made for the present application as well as the contents of the prior art references mentioned in this application are incorporated in this application by reference.

1. A UV laser system, comprising:
a laser light source for producing a basic wavelength laser light; and
a wavelength converting crystal for converting the basic wavelength laser into a UV laser light;
wherein the wavelength converting crystal is provided with a reflective plane that selectively reflects one of the basic wavelength laser light and the UV laser light to cause the UV laser light to emit from a part of the wavelength converting crystal different from an optical path of the basic wavelength laser light in the wavelength converting crystal.

2. The UV laser system according to claim 1, further comprising a device for converting a part of the basic wavelength laser light into a harmonic laser light, wherein the wavelength converting crystal is configured to sum frequency convert the basic wavelength laser and the harmonic laser light into the UV laser light

3. The UV laser system according to claim 2, wherein the reflective plane is configured to reflect the UV laser light and transmit the basic wavelength laser light and the harmonic laser light.

4. The UV laser system according to claim 3, wherein the reflective plane is configured to reflect the UV laser light in a perpendicular direction.

5. The UV laser system according to claim 3, wherein the reflective plane is configured to reflect the UV laser light at an oblique angle less than 90 degrees.

6. The UV laser system according to claim 2, wherein the reflective plane is configured to reflect the basic wavelength laser light and the second harmonic laser light and transmit the UV laser light.

7. The UV laser system according to claim 6, wherein the reflective plane is configured to reflect the basic wavelength laser light and the second harmonic laser light in a perpendicular direction.

8. The UV laser system according to claim 6, wherein the reflective plane is configured to reflect the basic wavelength laser light and the second harmonic laser light at an oblique angle less than 90 degrees.

9. The UV laser system according to claim 1, wherein the wavelength converting crystal comprises a first crystal having a first optical surface coated with a reflective coating and a second crystal having a second optical surface overlaid on the first optical surface to define the reflective plane.

10. The UV laser system according to claim 9, wherein the first crystal and the second crystal are joined to each other by optical contact at the first and second optical surfaces.

11. The UV laser system according to claim 9, wherein the first crystal is cut at a crystal cut angle meeting a phase matching condition, and the second crystal is cut at a crystal cut angle deviating from the phase matching condition.

12. The UV laser system according to claim 11, wherein the crystal cut angle of the second crystal deviates from that of the first crystal by 1 to 5 degrees.
